(19) United States
(12) Patent Application Publication
(10) Pub. No.: US 2022/0383192 A1
(43) Pub. Date: Dec. 1, 2022

(54) METHOD AND APPARATUS FOR PREDICTION BASED ON MODEL PREDICTED VALUES

(71) Applicant: SAMSUNG SDS CO., LTD., Seoul (KR)

(72) Inventors: Ji-Hoon KIM, Seoul (KR); Jong-Won CHOI, Seoul (KR); Kyoung-Jin OH, Seoul (KR)

(21) Appl. No.: 17/751,843

(22) Filed: May 24, 2022

(30) Foreign Application Priority Data
May 28, 2021 (KR) 10-2021-0069110

(51) Int. Cl. G06N 20/00

(52) U.S. Cl. CPC G06N 20/00

(57) ABSTRACT

A method for predicting a value for unlabeled data according to an embodiment is executed in a computing device including one or more processors and a memory storing one or more programs executed by the one or more processors. The method includes training a relation estimation model for predicting a label for labeled data based on a relation between respective predicted values of a plurality of pre-trained predictive models for the labeled data and a target model and obtaining a predicted value for unlabeled data based on the relation estimation model.

### CROSS-REFERENCE TO RELATED APPLICATION(S)

This application claims the benefit under 35 USC § 119 of Korean Patent Application No. 10-2021-0069110 filed on May 28, 2021, in the Korean Intellectual Property Office, the entire disclosure of which is incorporated herein by reference for all purposes.

### BACKGROUND

### 1. Field

Embodiments disclosed herein relate to a technology for prediction based on model predicted values.

### 2. Description of Related Art

These days, in the deep learning, in order to solve the problem of requiring large amounts of data to which labels are provided in supervised learning, research on technologies capable of learning even if label information does not exist in all datasets, such as semi-supervised learning, self-supervised learning, and active learning is being conducted.

However, in the existing methods, there is a limitation in that a new learning method has to be developed whenever a new problem is given, since the methods are implemented to train a model of a structure performing an automatic labeling process and infer label information for images without label information in a data set.

Transfer learning, which is applied when there are a small number of data sets, also has to perform a training process for each new model, which is a limitation in that it is not possible to consider two or more models or already trained data sets.

### SUMMARY

The embodiments disclosed herein are intended to provide a prediction technology for unlabeled data on basis of a relation between respective predicted values of a plurality of pre-trained predictive models and a target model.

In one general aspect, there is provided a method for prediction on basis of model predicted values that is executed in a computing device including one or more processors and a memory storing one or more programs executed by the one or more processors, and the method includes: training a relation estimation model for predicting a label for labeled data on basis of a relation between respective predicted values of a plurality of pre-trained predictive models for the labeled data and a target model; and obtaining a predicted value for unlabeled data on basis of the relation estimation model.

The relation estimation model may include an individual relation model that learns the relation between the respective predicted values of the plurality of pre-trained predictive models for the labeled data and the target model and an overall relation model that calculates attention weights by learning a relation between the respective predicted values of the plurality of pre-trained predictive models.

The attention weight may be a weight for each of the plurality of pre-trained predictive models determined based on the relation between the respective predicted values of the plurality of pre-trained predictive models and the target model.

The training of the relation estimation model may include training the individual relation model for predicting a label for labeled data on basis of the relation between the respective predicted values of the plurality of pre-trained predictive models for the labeled data and the target model, calculating attention weights for the relation between the respective predicted values of the plurality of pre-trained predictive models and the target model on basis of an output value of the individual relation model, and training the overall relation model for predicting a label for the labeled data on basis of the attention weights.

The training of the individual relation model may include generating respective first relation vectors for the relation between the respective predicted values of the plurality of pre-trained predictive models and the target model, converting a dimension of the respective first relation vectors into a dimension having the same size as the predicted value of the target model, and training the individual relation model such that losses of the label for the labeled data and the predicted values of the plurality of pre-trained predictive models are minimized on basis of the respective first relation vectors which have been dimensionally converted.

The calculating of the attention weights may include generating respective first relation vectors for the relation between the respective predicted values of the plurality of pre-trained predictive models and the target model, converting a dimension of the respective first relation vectors into a dimension having the same size as the predicted value of the target model, generating a second relation vector by concatenating the respective predicted values of the plurality of pre-trained predictive models and the target model, converting a dimension of the second relation vector into a dimension having the same size as the predicted value of the target model, and calculating the attention weight on basis of the respective first relation vectors which have been dimensionally converted and the second relation vector which has been dimensionally converted.

The training of the overall relation model may include generating a final predicted value by adding the attention weight to each of the predicted values of the plurality of pre-trained predictive models, and training the overall relation model such that a loss between the final predicted value and the label for the labeled data is minimized.

In another general aspect, there is provided an apparatus for prediction on basis of model predicted values, the apparatus including a relation trainer configured to train a relation estimation model for predicting a label for labeled data on basis of a relation between respective predicted values of a plurality of pre-trained predictive models for the labeled data and a target model and a relation-based reasoner configured to obtain a predicted value for unlabeled data on basis of the relation estimation model.

The relation estimation model may include an individual relation model that learns the relation between the respective predicted values of the plurality of pre-trained predictive models for the labeled data and the target model and an overall relation model that calculates attention weights by learning a relation between the respective predicted values of the plurality of pre-trained predictive models.

The attention weight may be a weight for each of the plurality of pre-trained predictive models determined on basis of the relation between the respective predicted values of the plurality of pre-trained predictive models and the target model.

The relation trainer may be configured to train the individual relation model for predicting a label for labeled data on basis of a relation between respective predicted values of the plurality of pre-trained predictive models for the labeled data and the target model, calculate attention weights for the relation between the respective predicted values of the plurality of pre-trained predictive models and the target model on basis of an output value of the individual relation model, and train the overall relation model for predicting a label for the labeled data on basis of the attention weight.

The relation trainer may be configured to generate respective first relation vectors for the relation between the respective predicted values of the plurality of pre-trained predictive models and the target model, convert a dimension of the respective first relation vectors into a dimension having the same size as the predicted value of the target model, and train the individual relation model such that losses of the label for the labeled data and the respective predicted values of the plurality of pre-trained predictive models and the target model are minimized on basis of the respective first relation vectors of which the dimensions have been converted.

The relation trainer may be configured to generate respective first relation vectors for the relation between the respective predicted values of the plurality of pre-trained predictive models and the target model, convert a dimension of the respective first relation vectors into a dimension having the same size as the predicted value of the target model, generate a second relation vector by concatenating the respective predicted values of the plurality of pre-trained predictive models and the target model, convert a dimension of the second relation vector into a dimension having the same size as the predicted value of the target model, and calculate the attention weights on basis of the respective first relation vectors which have been dimensionally converted and the second relation vector which has been dimensionally converted.

The relation trainer may be configured to generate a final predicted value by adding the attention weight to each of the predicted values of the plurality of pre-trained predictive models, and train the overall relation model such that a loss between the final predicted value and the label for the labeled data is minimized.

### BRIEF DESCRIPTION OF THE DRAWINGS

FIG. 1 is a block diagram of an apparatus for prediction on basis of a model predicted value according to an embodiment.

FIG. 2 is a configuration diagram of a relation estimation model trained by a relation trainer according to an embodiment.

FIG. 3 is a diagram for exemplarily illustrating a process of training a relation estimation model according to an embodiment.

FIG. 4 is a diagram for exemplarily illustrating a process of training an individual relation model according to an embodiment.

FIG. 5 is a diagram for exemplarily illustrating a process of training an overall relation model according to an embodiment.

FIG. 6 is a flowchart of a method for prediction on basis of a model predicted value according to an embodiment.

FIG. 7 is a block diagram for exemplarily illustrating a computing environment including a computing device according to an embodiment.

### DETAILED DESCRIPTION

Hereinafter, specific embodiments will be described with reference to the accompanying drawings. The following detailed description is provided to assist in a comprehensive understanding of the methods, devices and/or systems described herein. However, the detailed description is only for illustrative purposes and the disclosed embodiments are not limited thereto.

In describing the embodiments, when it is determined that detailed descriptions of related known technology may unnecessarily obscure the gist of the disclosed embodiments, the detailed descriptions thereof will be omitted. The terms used below are defined in consideration of functions in the disclosed embodiments, but may be changed depending on the customary practice or the intention of a user or operator. Thus, the definitions should be determined based on the overall content of the present specification. The terms used herein are only for describing the embodiments, and should not be construed as limitative. Unless expressly used otherwise, a singular form includes a plural form. In the present description, the terms “including”, “comprising”, “having”, and the like are used to indicate certain characteristics, numbers, steps, operations, elements, and a portion or combination thereof, but should not be interpreted to preclude one or more other characteristics, numbers, steps, operations, elements, and a portion or combination thereof.

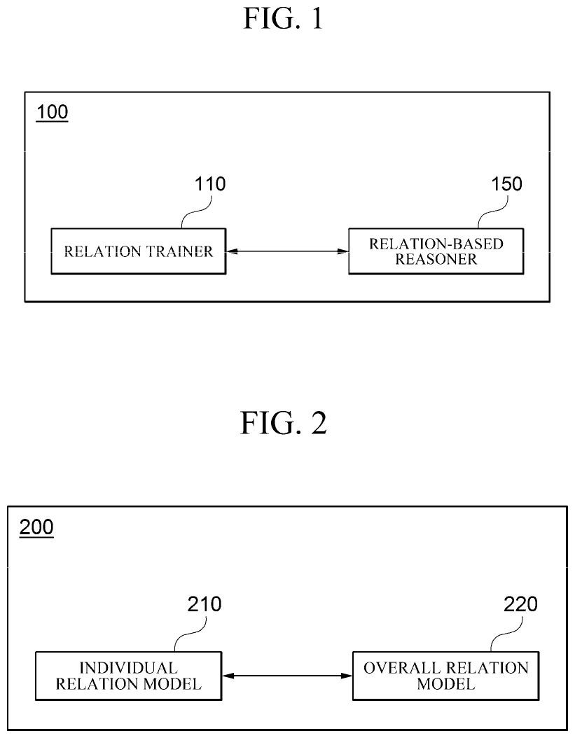

FIG. 1 is a block diagram of an apparatus for prediction on basis of a model predicted value according to an embodiment.

Referring to FIG. 1, an apparatus 100 for prediction (hereinafter, referred to as a ‘prediction apparatus’) based on model predicted values according to an embodiment includes a relation trainer 110 and a relation-based reasoner 150.

According to an embodiment, the relation trainer 110 and the relation-based reasoner 150 may be implemented using one or more physically separated devices, or may be implemented by one or more hardware processors or a combination of one or more hardware processors and software, and may not be clearly distinguished in specific operations, unlike the illustrated example.

The relation trainer 110 trains a relation estimation model for predicting a label for labeled data on basis of a relation between respective predicted values of a plurality of pre-trained predictive models for the labeled data and a target model.

The relation-based reasoner 150 obtains a predicted value for unlabeled data on basis of the relation estimation model.

The relation estimation model may mean a model for learning a relation between a plurality of pre-trained predictive models and a target model for solving a task.

According to an embodiment, the relation estimation model may include an individual relation model that learns the relation between the respective predicted values of the plurality of pre-trained predictive models for the labeled data and the target model and an overall relation model that calculates attention weights by learning a relation between the respective predicted values of the plurality of pre-trained predictive models.

In this case, according to an embodiment, the attention weight may be a weight for each of the plurality of pre-trained predictive models determined on basis of the relation between the respective predicted values of the plurality of pre-trained predictive models and the target model.

FIG. 2 is a configuration diagram of a relation estimation model trained by a relation trainer according to an embodiment.

Referring to FIG. 2, the relation estimation model 200 includes an individual relation model 210 and an overall relation model 220.

The individual relation model 210 may learn a relation between respective predicted values of a plurality of pre-trained predictive models for labeled data and a target model.

According to an embodiment, the individual relation model 210 may generate respective first relation vectors for the relation between the respective predicted values of the plurality of pre-trained predictive models and the target model.

According to an embodiment, the first relation vector may be generated by Equation 1 below.

$$p ( {y}_{0} , {z}_{i} ) = [ \begin{matrix}p ( {y}_{0} ) [ 1 ] \times p ( {z}_{i} ) [ 1 ] & … & p ( {y}_{0} ) [ 1 ] \times p ( {z}_{i} ) [ {m}_{i} ] \\ … & … & … \\ p ( {y}_{0} ) [ {c}_{0} ] \times p ( {z}_{i} ) [ 1 ] & … & p ( {y}_{0} ) [ {c}_{0} ] \times p ( {z}_{i} ) [ {m}_{i} ]\end{matrix} ] ∈ {ℝ}^{{c}_{0} \times {m}_{i}} \qquad [ Equation 1 ]$$

In this case, p(y₀, zᵢ) denotes a first relation vector indicating a relation between respective predicted values of a plurality of pre-trained predictive models for the labeled data and the target model, yo denotes a predicted value vector output from the target model, zᵢ denotes a predicted value vector output from the i-th model of the plurality of pre-trained predictive models, co denotes the size of the predicted value of the target model, and mi denotes the size of the predicted value of the i-th model included in the plurality of pre-trained predictive models.

Meanwhile, the first relation vector may be a probability matrix obtained by matrix multiplication of the predicted value of the pre-trained predictive model and the predicted value of the target model.

According to an embodiment, the first relation vector may have a dimension of a size that is different depending on the labeled data input to the pre-trained predictive model and the pre-trained predictive model.

According to an embodiment, the individual relation model 210 may convert the dimension of the respective first relation vectors into a dimension having the same size as the predicted value of the target model.

According to an embodiment, the dimension of the first relation vector may be converted by Equation 2 below.

G(y₀, zᵢ)=p(y₀, zᵢ)p(y₀, zᵢ)^{T} ∈ [symbol] ^{c}^{ₒ}^{×c}^{ₒ} [Equation 2]

In this case, G(y₀, zᵢ) denotes a first relation vector which has been dimensionally converted, p(y₀, zᵢ) denotes the first relation vector, and p(Y₀, zᵢ)^{T} denotes a transpose matrix vector of the first relation vector.

Then, the individual relation model 210 may be trained such that losses of the label for the labeled data and the respective predicted values of the plurality of pre-trained predictive models is minimized on basis of the respective first relation vectors which have been dimensionally converted.

The overall relation model 220 may calculate attention weights for a relation between respective predicted values of the plurality of pre-trained predictive models and the target model on basis of the output value of the individual relation model, and may predict a label for the labeled data on basis of the attention weight.

According to an embodiment, the overall relation model 220 may generate respective first relation vectors for the relation between the respective predicted values of the plurality of pre-trained predictive models and the target model.

According to an embodiment, the first relation vector may be generated by Equation 3 below.

$$p ( {y}_{0} , {z}_{i} ) = [ \begin{matrix}p ( {y}_{0} ) [ 1 ] \times p ( {z}_{i} ) [ 1 ] & … & p ( {y}_{0} ) [ 1 ] \times p ( {z}_{i} ) [ {m}_{i} ] \\ … & … & … \\ p ( {y}_{0} ) [ {c}_{0} ] \times p ( {z}_{i} ) [ 1 ] & … & p ( {y}_{0} ) [ {c}_{0} ] \times p ( {z}_{i} ) [ {m}_{i} ]\end{matrix} ] ∈ {ℝ}^{{c}_{0} \times {m}_{i}} \qquad [ Equation 3 ]$$

In this case, p(y₀, zᵢ) denotes a first relation vector indicating a relation between respective predicted values of a plurality of pre-trained predictive models for the labeled data and the target model, y₀ denotes a predicted value vector output from the target model, zᵢ denotes a predicted value vector output from the i-th model of the plurality of pre-trained predictive models, co denotes the size of the predicted value of the target model, and mi denotes the size of the predicted value of the i-th model included in the plurality of pre-trained predictive models.

Meanwhile, the first relation vector may be a probability matrix obtained by matrix multiplication of the predicted value of the pre-trained predictive model and the predicted value of the target model.

According to an embodiment, the first relation vector may have a dimension of a size that is different depending on the labeled data input to the pre-trained predictive model and the pre-trained predictive model.

According to an embodiment, the overall relation model 220 may convert the dimension of the respective first relation vectors into a dimension having the same size as the predicted value of the target model.

According to an embodiment, the dimension of the first relation vector may be converted by Equation 4 below.

G(y₀, zᵢ)=p(y₀, zᵢ)p(y₀, zᵢ)^{T} ∈ [symbol] ^{c}^{ₒ}^{×c}^{ₒ} [Equation 4]

In this case, G(y₀, zᵢ) denotes a first relation vector which has been dimensionally converted, p(y₀, zᵢ) denotes the first relation vector, and p(y₀, zᵢ)^{T} denotes a transpose matrix vector of the first relation vector.

Meanwhile, according to an embodiment, the overall relation model 220 may calculate attention weights for the relation between the respective predicted values of the plurality of pre-trained predictive models and the target model on basis of an output value of the individual relation model.

First, according to an embodiment, the overall relation model 220 may generate a second relation vector by concatenating the respective predicted values of the plurality of pre-trained predictive models and the target model, and may convert a dimension of the second relation vector into a dimension having the same size as the predicted value of the target model.

According to an embodiment, the dimension of the second relation vector may be synthesized by Equation 5 below.

$$p ( {y}_{0} , {x}_{i} ) = [ \begin{matrix}p ( {y}_{0} ) [ 1 ] \times p ( {x}_{i} ) [ 1 ] & … & p ( {y}_{0} ) [ 1 ] \times p ( {x}_{i} ) [ {t}_{i} ] \\ … & … & … \\ p ( {y}_{0} ) [ {c}_{0} ] \times p ( {x}_{i} ) [ 1 ] & … & p ( {y}_{0} ) [ {c}_{0} ] \times p ( {x}_{i} ) [ {t}_{i} ]\end{matrix} ] ∈ {ℝ}^{{c}_{0} \times {t}_{i}} \qquad [ Equation 5 ]$$

In this case, p(y₀, xᵢ) denotes the second relation vector, y₀ denotes the predicted value vector output from the target model, zᵢ denotes the vector to which the predicted values output from the plurality of pre-trained predictive models are concatenated, c₀ denotes the size of y₀, and tᵢ denotes the size of xᵢ (sum of the sizes of the predicted values of the i-th model included in the plurality of pre-trained predictive models).

According to an embodiment, the overall relation model 220 may convert the dimension of each second relation vector into a dimension having the same size as the predicted value of the target model.

Then, according to an embodiment, the overall relation model 220 may calculate an attention weight for each of a plurality of pre-trained predictive models on basis of the respective first relation vectors which have been dimensionally converted and the second relation vector which has been dimensionally converted, and may generate a final predicted value by adding the attention weight to each of the predicted values of the plurality of pre-trained predictive models.

According to an embodiment, the final predicted value for predicting a label for labeled data on basis of the attention weight may be calculated by Equation 6 below.

$$( {y}_{0} , {w}_{i} ) = [ \begin{matrix}p ( {y}_{1} ) [ 1 ] \times w [ 1 ] & … & p ( {y}_{1} ) [ {c}_{0} ] \times w [ 1 ] \\ … & … & … \\ p ( {y}_{m} ) [ 1 ] \times w [ m ] & … & p ( {y}_{m} ) [ {c}_{0} ] \times w [ m ]\end{matrix} ] ∈ {ℝ}^{m \times {c}_{0}} \qquad [ Equation 6 ]$$

In this case, (yᵢ, wᵢ) denotes the final predicted value used in the relation-based reasoning process, and wᵢ denotes the attention weight of the i-th model of the plurality of pre-trained predictive models.

Then, according to an embodiment, the overall relation model 220 may be trained such that the loss between the final predicted value and the label for the labeled data is minimized.

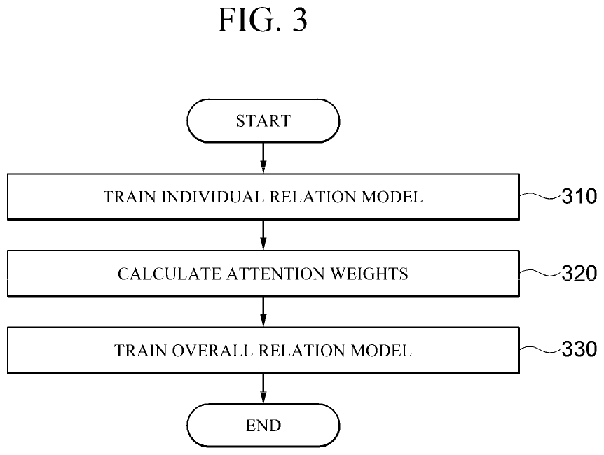

FIG. 3 is a diagram for exemplarily illustrating a process of training a relation estimation model according to an embodiment. In the illustrated flowchart, the method is divided into a plurality of steps; however, at least some of the steps may be performed in a different order, performed together in combination with other steps, omitted, performed in subdivided steps, or performed by adding one or more steps not illustrated.

The method illustrated in FIG. 3 may be performed, for example, by the relation trainer 110 illustrated in FIG. 1.

Referring to FIG. 3, the relation trainer 110 trains an individual relation model for predicting a label for labeled data on basis of a relation between respective predicted values of a plurality of pre-trained predictive models for the labeled data and a target model (310).

Meanwhile, according to an embodiment, the relation trainer 110 may generate respective first relation vectors for the relation between the respective predicted values of the plurality of pre-trained predictive models and the target model, convert a dimension of respective first relation vectors into a dimension having the same size as the predicted value of the target model, and train the individual relation model such that losses of the label for the labeled data and the respective predicted values of the plurality of pre-trained predictive models are minimized on basis of the respective first relation vectors which have been dimensionally converted.

Then, according to an embodiment, the relation trainer 110 calculates attention weights for the relation between the respective predicted values of the plurality of pre-trained predictive models and the target model on basis of an output value of the individual relation model (320).

In this case, according to an embodiment, the relation trainer 110 may generate respective first relation vectors for the relation between the respective predicted values of the plurality of pre-trained predictive models and the target model, convert a dimension of the respective first relation vectors into a dimension having the same size as the predicted value of the target model, generate a second relation vector by concatenating the respective predicted values of the plurality of pre-trained predictive models and the target model, convert a dimension of the second relation vector into a dimension having the same size as the predicted value of the target model, and calculate the attention weight on basis of the respective first relation vectors which have been dimensionally converted and the second relation vector which has been dimensionally converted.

Then, according to an embodiment, the relation trainer 110 trains the overall relation model for predicting the label for the labeled data on basis of the attention weights (330).

In this case, according to an embodiment, the relation trainer 110 may generate a final predicted value by adding the attention weight to each of the predicted values of the plurality of pre-trained predictive models, and train the overall relation model such that the loss between the final predicted value and the label of the labeled data is minimized.

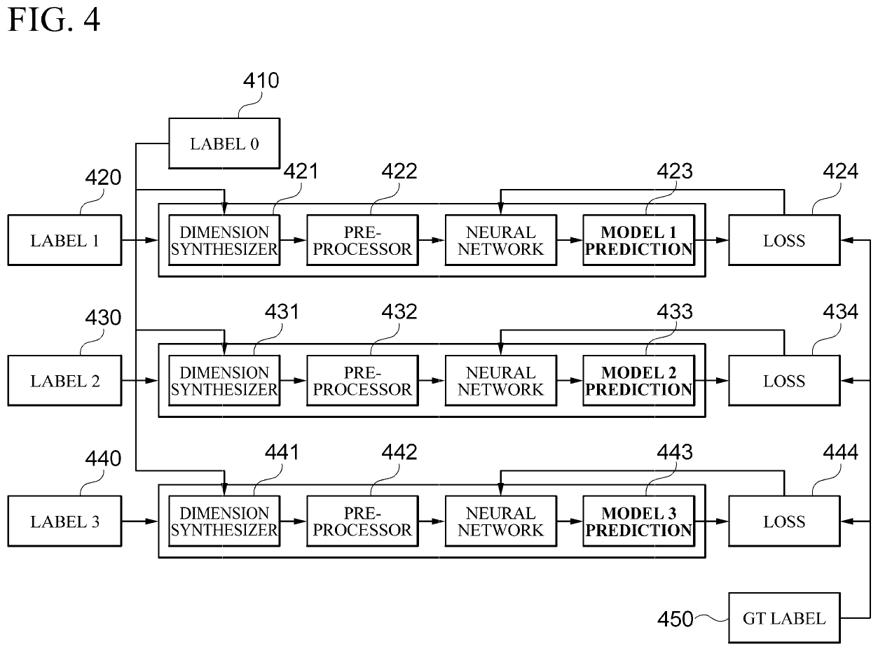

FIG. 4 is a diagram for exemplarily illustrating a process of training an individual relation model according to an embodiment.

A process illustrated in FIG. 4 may be performed, for example, by the relation trainer 110 illustrated in FIG. 1.

Meanwhile, according to an embodiment, the relation trainer 110 may generate respective first relation vectors for the relation between the respective predicted values of the plurality of pre-trained predictive models and the target model, convert a dimension of respective first relation vectors into a dimension having the same size as the predicted value of the target model, and train the individual relation model such that losses of the label for the labeled data and the respective predicted values of the plurality of pre-trained predictive models are minimized on basis of the respective first relation vectors which have been dimensionally converted.

Specifically, referring to FIG. 4, dimension synthesizers 421, 431, and 441 of the individual relation model may generate respective first relation vectors by combining labels (Label 1, Label 2, and Label 3) 420, 430, and 440 of pre-trained predictive models 1, 2, and 3 and Label 0, which is the predicted value of the target model.

Then, pre-processors 422, 432, and 442 of the individual relation model may convert the dimension of the respective first relation vectors into a dimension having the same size as the predicted value of the target model.

The relation trainer 110 may train the individual relation model such that losses 424, 434, and 444 of the label for the labeled data and respective predicted values 423, 433, and 443 of the plurality of pre-trained predictive models are minimized on basis of the respective first relation vectors which have been dimensionally converted.

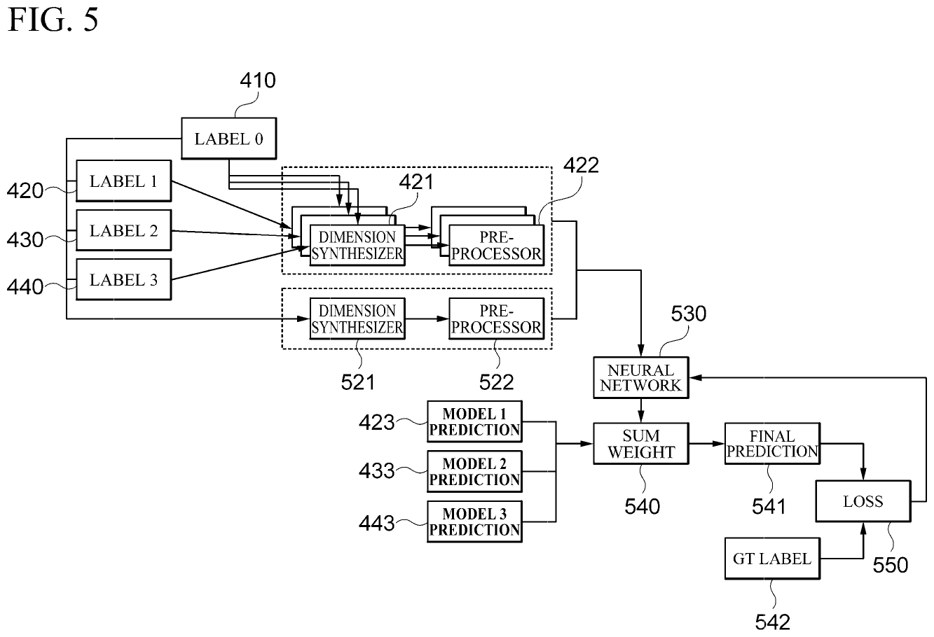

FIG. 5 is a diagram for exemplarily illustrating a process of training an overall relation model according to an embodiment.

The process illustrated in FIG. 5 may be performed, for example, by the relation trainer 110 illustrated in FIG. 1.

According to an embodiment, the relation trainer 110 may generate respective first relation vectors for the relation between the respective predicted values of a plurality of pre-trained predictive models and a target model, and may convert a dimension of the respective first relation vectors into a dimension having the same size as the predicted value of the target model.

Specifically, referring to FIG. 5, a dimension synthesizers 421 of the overall relation model may generate respective first relation vectors by combining labels (Label 1, Label 2, and Label 3) 420, 430, and 440 of pre-trained predictive models 1, 2, and 3 and Label 0, which is the predicted value of the target model. Then, a pre-processor 422 of the overall relation model may convert the dimension of the respective first relation vectors into a dimension having the same size as the predicted value of the target model.

According to an embodiment, a relation trainer 110 may generate a second relation vector by concatenating the respective predicted values of the plurality of pre-trained predictive models and the target model, and may convert a dimension of the second relation vector into a dimension having the same size as the predicted value of the target model.

Specifically, a dimension synthesizer 521 of the overall relation model may generate a second relation vector by concatenating labels (Label 1, Label 2, and Label 3) 420, 430, and 440 of a plurality of pre-trained predictive models 1, 2, and 3 and then combining the concatenated label with Label 0, which is the predicted value of the target model. Then, a pre-processor 522 of the overall relation model may convert the dimension of the second relation vectors into a dimension having the same size as the predicted value of the target model.

According to an embodiment, the relation trainer 110 may calculate attention weights through an attention network 530 of the overall relation model on basis of the respective first relation vectors which have been dimensionally converted and the second relation vector which has been dimensionally converted.

Then, according to an embodiment, the relation trainer 110 may generate a final predicted value 541 by adding (540) the attention weight to each of the predicted values 423, 433, and 443 of the plurality of pre-trained predictive models, and may train the overall relation model such that the loss 550 between the final predicted value and the label 542 for the labeled data is minimized.

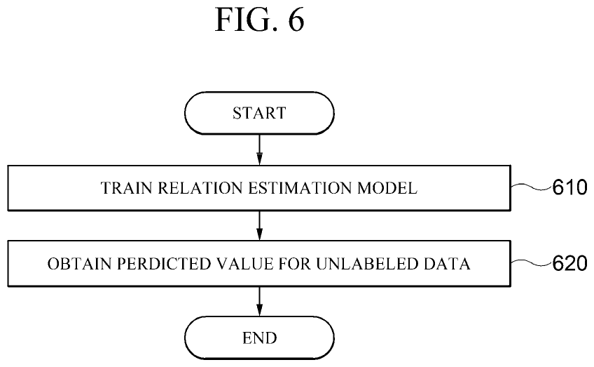

FIG. 6 is a flowchart of a method for prediction on basis of a model predicted value according to an embodiment.

The method illustrated in FIG. 6 may be performed, for example, by the prediction apparatus 100 on basis of the model predicted values illustrated in FIG. 1.

Referring to FIG. 6, the prediction apparatus 100 trains a relation estimation model for predicting a label for labeled data on basis of a relation between respective predicted values of a plurality of pre-trained predictive models for the labeled data and a target model (610).

Then, the prediction apparatus 100 obtains a predicted value for unlabeled data on basis of the relation estimation model (620).

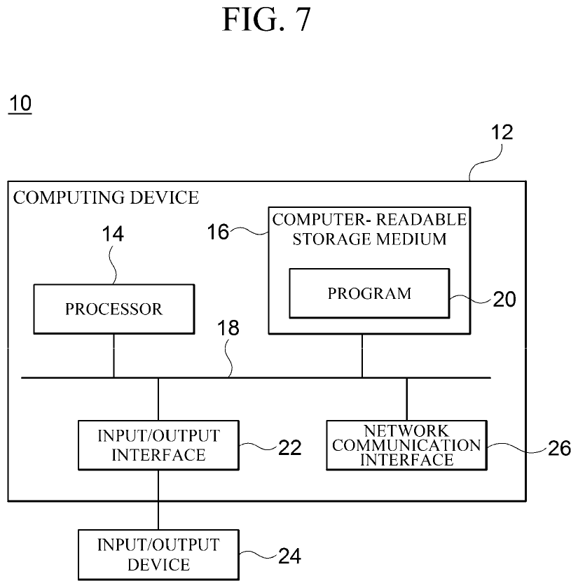

FIG. 7 is a block diagram for exemplarily illustrating a computing environment 10 including a computing device according to an embodiment. In the illustrated embodiment, each component may have different functions and capabilities in addition to those described below, and additional components may be included in addition to those described below.

The illustrated computing environment 10 includes a computing device 12. In an embodiment, the computing device 12 may be the prediction apparatus 100 on basis of the model predicted values shown in FIG. 1.

The computing device 12 includes at least one processor 14, a computer-readable storage medium 16, and a communication bus 18. The processor 14 may cause the computing device 12 to operate according to the above-described exemplary embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the exemplary embodiments.

The computer-readable storage medium 16 is configured to store computer-executable instructions or program codes, program data, and/or other suitable forms of information. A program 20 stored in the computer-readable storage medium 16 includes a set of instructions executable by the processor 14. In an embodiment, the computer-readable storage medium 16 may be a memory (a volatile memory such as a random-access memory, a non-volatile memory, or any suitable combination thereof), one or more magnetic disk storage devices, optical disc storage devices, flash memory devices, other types of storage media that are accessible by the computing device 12 and may store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The exemplary input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, an interlocutor, and/or a network card. The exemplary input/output device 24 may be included inside the computing device 12 as a component constituting the computing device 12, or may be connected to the computing device 12 as a separate device distinct from the computing device 12.

Meanwhile, the embodiments of the present invention may include a program for performing the methods described herein on a computer, and a computer-readable recording medium including the program. The computer-readable recording medium may include program instructions, a local data file, a local data structure, or the like alone or in combination. The media may be specially designed and configured for the present disclosure, or may be commonly used in the field of computer software. Examples of computer-readable recording media include magnetic media such as hard disks, floppy disks and magnetic tapes, optical recording media such as a CD-ROM and a DVD, and hardware devices specially configured to store and execute program instructions such as a ROM, a RAM, and a flash memory. Examples of the program may include not only machine language codes such as those produced by a compiler, but also high-level language codes that can be executed by a computer using an interpreter or the like.

According to the embodiment disclosed herein, by utilizing the correlation between the environment in which each of the plurality of pre-trained models is trained and the data to be currently learned, it is possible to increase the accuracy of the predicted value with only a small amount of data.

Further, by simultaneously utilizing a plurality of pre-trained models, it is possible to increase the accuracy of the predicted value.

Further, by utilizing the relation between the respective predicted values of the plurality of pre-trained predictive models and the target model, it is possible to make prediction regardless of the structural relation between the plurality of pre-trained models and the target model, and to make prediction even when the structure of each of the plurality of pre-trained models is not known.

Although the representative embodiments of the present disclosure have been described in detail as above, those skilled in the art will understand that various modifications may be made thereto without departing from the scope of the present disclosure. Therefore, the scope of rights of the present disclosure should not be limited to the described embodiments, but should be defined not only by the claims set forth below but also by equivalents of the claims.

What is claimed is:

1. A method for predicting a value for unlabeled data, the method executed in a computing device including one or more processors and a memory storing one or more programs executed by the one or more processors, the method comprising:
training a relation estimation model for predicting a label for labeled data, on basis of a relation between respective predicted values of a plurality of pre-trained predictive models for the labeled data and a target model; and
obtaining a predicted value for unlabeled data on basis of the relation estimation model.

2. The method of claim 1, wherein the relation estimation model includes:
an individual relation model that learns the relation between the respective predicted values of the plurality of pre-trained predictive models for the labeled data and the target model; and
an overall relation model that calculates attention weights by learning a relation between the respective predicted values of the plurality of pre-trained predictive models.

3. The method of claim 2, wherein the attention weight is a weight for each of the plurality of pre-trained predictive models, and the attention weight is determined based on the relation between the respective predicted values of the plurality of pre-trained predictive models and the target model.

4. The method of claim 2, wherein the training of the relation estimation model includes:
training the individual relation model for predicting a label for labeled data based on the relation between the respective predicted values of the plurality of pre-trained predictive models for the labeled data and the target model;
calculating, on basis of an output value of the individual relation model, attention weights for the relation between the respective predicted values of the plurality of pre-trained predictive models and the target model; and
training the overall relation model for predicting a label for the labeled data based on the attention weights.

5. The method of claim 4, wherein the training of the individual relation model includes:
generating respective first relation vectors for the relation between the respective predicted values of the plurality of pre-trained predictive models and the target model;
converting a dimension of the respective first relation vectors into a dimension having the same size as the predicted value of the target model; and
training the individual relation model such that losses of the label for the labeled data and the predicted values of the plurality of pre-trained predictive models are minimized, on basis of the respective first relation vectors which have been dimensionally converted.

6. The method of claim 5, wherein the calculating of the attention weights includes:
generating respective first relation vectors for the relation between the respective predicted values of the plurality of pre-trained predictive models and the target model;
converting a dimension of the respective first relation vectors into a dimension having the same size as the predicted value of the target model;
generating a second relation vector by concatenating the respective predicted values of the plurality of pre-trained predictive models and the target model;
converting a dimension of the second relation vector into a dimension having the same size as the predicted value of the target model; and
calculating the attention weight, on basis of the respective first relation vectors which have been dimensionally converted and the second relation vector which has been dimensionally converted.

7. The method of claim 4, wherein the training of the overall relation model includes:
generating a final predicted value by adding the attention weight to each of the predicted values of the plurality of pre-trained predictive models; and
training the overall relation model such that a loss between the final predicted value and the label for the labeled data is minimized.

8. An apparatus for prediction based on model predicted values, the apparatus comprising:
a relation trainer configured to train a relation estimation model for predicting a label for labeled data based on a relation between respective predicted values of a plurality of pre-trained predictive models for the labeled data and a target model; and
a relation-based reasoner configured to obtain a predicted value for unlabeled data based on the relation estimation model.

9. The apparatus of claim 8, wherein the relation estimation model includes:
an individual relation model that learns the relation between the respective predicted values of the plurality of pre-trained predictive models for the labeled data and the target model; and
an overall relation model that calculates attention weights by learning a relation between the respective predicted values of the plurality of pre-trained predictive models.

10. The apparatus of claim 9, wherein the attention weight is a weight for each of the plurality of pre-trained predictive models determined based on a relation between the respective predicted values of the plurality of pre-trained predictive models and the target model.

11. The apparatus of claim 9, wherein the relation trainer is configured to:
train the individual relation model for predicting a label for labeled data based on a relation between respective predicted values of the plurality of pre-trained predictive models for the labeled data and the target model;
calculate, on basis of an output value of the individual relation model, attention weights for the relation between the respective predicted values of the plurality of pre-trained predictive models and the target model; and
train the overall relation model for predicting a label for the labeled data based on the attention weights.

12. The apparatus of claim 11, wherein the relation trainer is configured to:
generate respective first relation vectors for the relation between the respective predicted values of the plurality of pre-trained predictive models and the target model;
convert a dimension of the respective first relation vectors into a dimension having the same size as the predicted value of the target model; and
train the individual relation model such that losses of the label for the labeled data and the respective predicted values of the plurality of pre-trained predictive models and the target model are minimized, on basis of the respective first relation vectors which have been dimensionally converted.

13. The apparatus of claim 12, wherein the relation trainer is configured to:
generate respective first relation vectors for the relation between the respective predicted values of the plurality of pre-trained predictive models and the target model, and converts a dimension of the respective first relation vectors into a dimension having the same size as the predicted value of the target model;
generate a second relation vector by concatenating the respective predicted values of the plurality of pre-trained predictive models and the target model, and converts a dimension of the second relation vector into a dimension having the same size as the predicted value of the target model; and
calculate the attention weights based on the respective first relation vectors which have been dimensionally converted and the second relation vector which has been dimensionally converted.

14. The apparatus of claim 11, wherein the relation trainer is configured to generate a final predicted value by adding the attention weight to each of the predicted values of the plurality of pre-trained predictive models, and train the overall relation model such that a loss between the final predicted value and the label for the labeled data is minimized.
